(19) United States
(12) Patent Application Publication
(10) Pub. No.: US 2017/0058842 A1
(43) Pub. Date: Mar. 2, 2017

(54) HEAT EXCHANGER FOR INTERNAL COMBUSTION ENGINES

(71) Applicant: BORGWARNER EMISSIONS SYSTEMS SPAIN, S.L.U., Vigo-Pontevedra (ES)

(72) Inventors: José Antonio Grande Fernández, Vigo-Pontevedra (ES); Germán Troncoso, Vigo-Pontevedra (ES)

(21) Appl. No.: 15/252,619

(22) Filed: Aug. 31, 2016

(30) Foreign Application Priority Data
Aug. 31, 2015 (EP) 15382434.7

(51) Int. Cl. F02M 26/32; F28F 13/06

(52) U.S. Cl. CPC F02M 26/32; F28F 13/06

(57) ABSTRACT

Provided are heat exchangers for internal combustion engines wherein a first fluid, preferably a hot gas, gives off its heat to a second fluid, preferably a coolant liquid. The presently disclosed heat exchangers include caps that limit the heat exchange capacity of the exchanger without causing differential expansions between elements or parts of these elements that may damage the device or reduce its service life due to thermal fatigue. A device of the presently disclosed subject matter can be sized for the engine having a higher rated power, and the same heat exchanger, can be adapted for operating with engines having a lower rated power without the velocity of the gas to be cooled being reduced, thereby preventing the accumulation of particles therein or fouling.

### CROSS REFERENCE TO RELATED APPLICATION

This application claims the benefit of European Patent Application EP15382434, filed Aug. 31, 2015, the disclosure of which is incorporated by reference herein in its entirety.

### TECHNICAL FIELD

The present invention relates to a heat exchanger for internal combustion engines where a first fluid, preferably a hot gas, gives off its heat to a second fluid, preferably a coolant liquid.

The heat exchanger is formed, among other elements, by a plurality of heat exchange tubes with a specific configuration: the exchange tubes comprise inner fins extending along the longitudinal direction of said exchange tube and internally configure a plurality of inner channels. Additionally, the exchanger comprises caps which are consecutively connected and attached by means of a connecting segment. Each of the caps is inserted in an end of a different exchange tube, covering one or more of the channels thereof to reduce the passage section thereof.

Manufacturing heat exchangers for internal combustion engines having a different rated power requires resizing or even redesigning the heat exchanger, depending on whether it is an engine having a higher rated power or a lower rated power. Designing and manufacturing a plurality of exchangers gives rise to a larger number of different parts and high manufacturing costs. Manufacturing costs are also increased by the use of a larger number of references.

The present invention has caps that limit the heat exchange capacity of the exchanger without causing differential expansions between elements or parts of these elements that may damage the device or reduce its service life due to thermal fatigue.

A device thus configured according to the invention can be sized for the engine having a higher rated power, and the same heat exchanger can be adapted for operating with engines having a lower rated power without reducing the velocity of the gas to be cooled, thereby preventing the accumulation of particles therein or fouling.

### BACKGROUND

Manufacturing engines having different rated powers, even for one and the same type of vehicle, requires each type of engine to have components specifically configured and sized according to its rated power.

For example, if an engine manufacturer has a range of engines having a different rated power with an EGR (Exhaust Gas Recirculation) system for reintroducing exhaust gas at the intake and thereby reducing nitrogen oxide emission in the exhaust, each of the EGR systems has components sized according to the recirculated hot gas flow rates. In turn, the recirculated hot gas flow rate also depends on the rated power of each engine. Particularly, the heat exchanger responsible for cooling recirculated gas will be sized according to the flow rate of the hot gas to be cooled. In other words, if the rated powers of the engines in a specific range are different enough, it may even be necessary to design and manufacture a different heat exchanger for each engine model according to its rated power.

The heat exchanger of an EGR system is one example; nevertheless, an internal combustion engine has other heat exchangers with other specific uses which can likewise require a different design and also different production lines.

According to the state of the art, if a heat exchanger that is large enough to cool a higher flow rate, i.e., the flow rate of the engine having a higher rated power, is designed and manufactured to avoid using different heat exchanger sizes, this heat exchanger is not suitable for engines having a lower rated power.

An oversized heat exchanger is capable of expelling heat in smaller flows, for example EGR gas flows; nevertheless, the passage of the flow through oversized conduits gives rise to very low flow velocities. The low velocity of a gas containing particles in suspension, such as those particles generated in the combustion chamber, causes said particles to accumulate in the conduits and to not be entrained by the gas. The progressive accumulation of particles blocks the conduits until rendering the device completely or partially useless.

Nor is it considered suitable to disable one or more gas conduits in a heat exchanger for the purpose of reducing its capacity and adapting it to an engine having a lower rated power since the different temperature of one heat exchange tube with respect to another, which would be the case when comparing a disabled tube with another operative tube, causes a differential longitudinal expansion. Since heat exchange tubes usually extend between two baffles, each of the baffles receiving the end of all the tubes, the differential expansion of the tubes causes stresses in at least the attachment between the tube and the baffle and therefore rupture due to thermal fatigue.

### SUMMARY

The present invention relates to a heat exchanger that accepts being adapted for a wide range of flows of a fluid to be cooled without the velocity of said fluid being reduced, and without there being differential expansions in its exchange tubes. As a result, the invention provides a heat exchanger that does not accumulate particles due to the low velocities of the flow to be cooled, nor does it suffer from thermal fatigue because there are heat exchange tubes with significant temperature differences.

The design of the heat exchanger according to the invention allows, for a range of internal combustion engines with different rated powers, making it possible to manufacture a single heat exchanger and for said heat exchanger to be easily configured according to the flow rate of the fluid to be cooled, and therefore according to the rated power of the engine, drastically reducing manufacturing costs.

A first aspect of the invention is a heat exchanger for internal combustion engines that allows being configured for operating with a given flow rate of a gas to be cooled. The configuration is carried out by partially limiting the heat exchange tubes such that the previously identified technical problems do not arise.

The heat exchanger according to this first inventive aspect comprises:

a bundle of exchange tubes for the exchange of heat between a hot gas and a coolant fluid; wherein the exchange tubes are tubes configured as planar tubes, with inner fins, extending according to a longitudinal direction (X-X′), and wherein the inner fins internally configure a plurality of channels extended according to said longitudinal direction (X-X′) and distributed according to a transverse direction (Y-Y′) with respect to said longitudinal direction (X-X′).

The exchange of heat between the hot gas and the coolant is carried out through the-exchange tubes. Hot gas circulates within the exchange tubes and the coolant fluid flows on the outside of the exchange tubes, expelling heat.

The exchange tubes have inner fins. The inner fins favor the exchange of heat between the exchange tube and the hot gas circulating therein. Additionally, the fins compartmentalize the inside of the tube by defining channels extending along the longitudinal direction (X-X′) of the exchange tube. The fins are partition walls between each of the channels such that it is possible for a given flow to circulate through one channel and for the flow to be nil or different in another channel.

The fins do not necessarily have to establish a completely leak-tight barrier between channels; nevertheless, if there is a flow between channels through the wall formed by the fin, said flow must be insignificant with respect to the main flow through the channels located on either side of said fin.

Considering the section of the tube, the channels are distributed along a given direction (Y-Y′), which direction is transverse or essentially perpendicular to the longitudinal direction (X-X′). According to the preferred embodiments of the invention, the section of the exchange tube corresponds to the section of a planar tube. A planar tube embodiment is one in which the section thereof is demarcated between two straight segments connected at their ends by two arcs. The central line parallel to the straight segments corresponds to the transverse direction (Y-Y′). In this same embodiment, according to the section of the exchange tube, the inner channels are aligned consecutively along the transverse direction (Y-Y′) showing two channels at the ends of the section having larger dimensions, i.e., the channels corresponding to the terminations by means of the arcuate segments.

Considering the longitudinal direction (X-X′), the inner fins do not have to extend between the final ends of the exchange tubes, but rather according to the preferred embodiments, the fins are offset towards the inside of the exchange tube.

Additionally, the heat exchanger according to this first inventive aspect comprises:

at least one element configured as a plurality of caps consecutively connected and attached by means of a connecting segment, each of the caps housed in one end of a different exchange tube, covering one or more of the channels thereof to reduce the passage section thereof.

The heat exchanger has at least one element which is formed by a plurality of caps. Each cap is housed in one end of an exchange tube, covering one or more of the channels thereof such that the passage section thereof is reduced. The element has connecting segments linking each cap with the next one.

The caps are configured for accepting insertion in the ends of the exchange tubes such that each cap is housed in one end of an exchange tube and the connecting segment is outside the exchange tubes, maintaining the link between consecutive caps.

Each cap covers one or more channels of the exchange tube in which it is housed. The channel that is covered by the cap no longer allows passage therethrough of the gas to be cooled, so there are fewer effective channels in the exchange tube, resulting in the passage section of the exchange tube being reduced.

The preferred embodiments of the invention make use of planar tubes where the channels are aligned according to a cross-section view of the exchange tube. In these embodiments the caps cover for example the outermost channel, the channel that is demarcated by an arc joining both straight segments of the exchange tube, and at least one or more inner channels.

Although the exchange tubes have channels that are disabled because in the hot gas inlet end there is a cap covering said channels, they continue to receive hot gas, and the plurality of exchange tubes continues to be operative since they all receive hot gas. Therefore, there are no tubes with different temperatures that can generate stresses and thermal fatigue.

Likewise, the reduction of the number of channels in each of the exchange tubes reduces the passage section of the bundle of tubes, increasing the velocity of the gas to be cooled with respect to the velocity it would have if none of the passage channels were covered by a cap. By keeping the velocity of passage high, fouling due to particles generated for example in the combustion chamber is prevented.

Various particular configurations of the caps and the heat exchanger comprising said caps for limiting its exchange section are shown in the preferred embodiments that will be described with the aid of the drawings.

A second aspect of the invention is the manufacturing method for manufacturing a heat exchanger, the method particularly comprising the steps that allow limiting the exchange section by means of the element configured as a plurality of caps consecutively connected and attached by means of a connecting segment. The method comprises the following steps:
providing a heat exchanger for internal combustion engines, comprising a bundle of exchange tubes, wherein said exchange tubes are tubes configured as planar tubes, with inner fins, extending according to a longitudinal direction (X-X′), and wherein the inner fins internally configure a plurality of channels extended according to said longitudinal direction (X-X′) and distributed according to a transverse direction (Y-Y′) with respect to said longitudinal direction (X-X′), the exchange tubes being extended between a first baffle and a second baffle,
providing a flow-limiting element configured as a plurality of caps consecutively connected and attached by means of a connecting segment,
arranging the heat exchanger in fixing means,
arranging the flow-limiting element in a plurality of punches, movable in the longitudinal direction (X-X′) established by the exchange tubes of the heat exchanger once it is fixed in the fixing means, such that:
   each cap is housed on a different punch,
   each cap housed on a punch is aligned with a different exchange tube,
moving the punches in the longitudinal direction until inserting all the caps in their corresponding hybrid tube,
removing the punches,
releasing the heat exchanger.

Each of the caps is configured for being housed in one end of an exchange tube. The caps are housed in the end of the exchange tube by insertion such that the heat exchanger formed by at least the bundle of tubes and the baffles between which the bundle of tubes extend is initially fixed in a support with fixing means.

Once the heat exchanger is fixed, it has punches that are aligned with the exchange tubes. These punches are provided with a movement according to the longitudinal direction of their corresponding exchange tube.

Each cap of the element comprising the plurality of caps is housed in a punch. As will be described in the preferred embodiments of the invention, the caps have an outer surface which is what is in contact with the inner walls of the exchange tube, and it in turn has an inner surface which is what accepts or houses the punch.

The movement of the punches in the longitudinal direction towards the inside of their corresponding exchange tubes causes the insertion of each of the caps in said exchange tubes. Once the caps are inserted in the ends of the exchange tubes, the retention between each cap and its corresponding exchange tube is formed, by friction for example; and when the punches are subsequently removed, said caps are housed in the exchange tube in their final position.

Once the caps are housed in the exchange tubes, the heat exchanger is released, being able to perform later steps for example for the finishing thereof. An example of an additional step could be the inclusion of intake manifolds or other elements which leave the caps in spaces that are no longer readily accessible once they are definitively closed.

### BRIEF DESCRIPTION OF THE DRAWINGS

The foregoing and other features and advantages of the invention will be more clearly understood based on the following detailed description of a preferred embodiment, given only by way of illustrative and non-limiting example, in reference to the attached drawings.

FIG. 1 shows a first embodiment of an element with caps intended for limiting the passage section of a plurality of exchange tubes.

FIG. 2 shows a section of an end of a heat exchanger. The drawing partially shows a heat exchange tube, the baffle to which the heat exchanger is attached and a section of a cap according to the first embodiment housed in the end of the heat exchange tube.

FIG. 3 shows a section like that in the preceding drawing where the configuration of the inner fins of the exchange tube has a termination in a different position with respect to the cap.

FIG. 4 shows a second embodiment of an element with caps attached by a connecting segment configured for being elastically deformable.

FIG. 5A shows a side view of the end of the heat exchanger where at least two heat exchange tubes projecting from the baffle as well as an elastically deformable connecting segment can be seen. The A-A plane through which the section of the following figure is formed is indicated in this figure.

FIG. 5B shows section A-A identified in preceding FIG. 5A.

FIGS. 6A-6C show the sequence followed during the method for inserting caps in the ends of the exchange tubes.

FIG. 7 shows a perspective view of the same end of the heat exchanger in order to see in detail the caps housed in the ends of the exchange tubes and particularly their internally housed closure surface.

FIG. 8 shows the same detail as in the preceding figure but now the perspective almost coincides with the longitudinal direction of the exchanger.

FIG. 9 shows the same detail as in the preceding figure in a cross-section view according to a plane central to one of the heat exchange tubes.

### DETAILED DESCRIPTION

According to the first inventive aspect, the present invention relates to a heat exchanger for internal combustion engines which is capable of being configured for different flow rate requirements for a flow to be cooled according to the rated power of the engine in which it is installed.

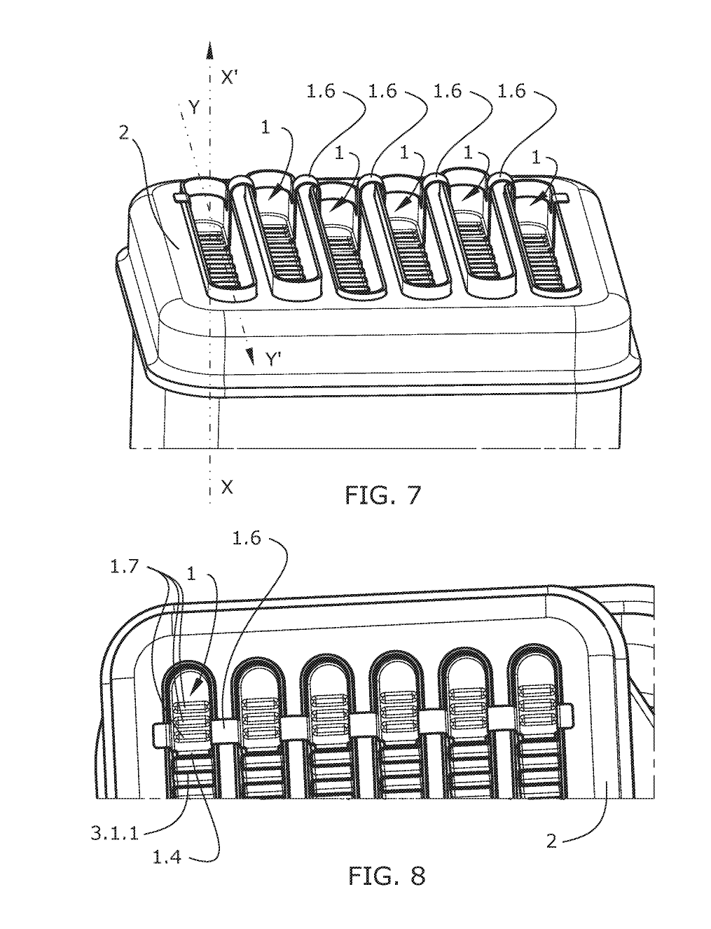

The heat exchanger comprises planar exchange tubes. According to the embodiments shown in FIGS. 2, 3, 5A, 5B, 6A, 6B, 6C, 7, 8, and 9, the configuration of the planar tubes comprises two parallel plates connected laterally by a semicylindrical segment. This sectional configuration results in two straight segments connected at their ends by respective arcs. This configuration is clearly shown for example in FIG. 7, where the ends of the exchange tubes (3) project from a baffle (2) closing the heat exchanger on the hot gas intake side.

Although the invention can be applied to heat exchangers without a shell, when the coolant fluid is air for example, the heat exchangers described in these embodiments comprise a shell (4) housing the bundle of exchange tubes (3). The coolant fluid is liquid and has an inlet (4.1), and it comes out of the shell after immersing the heat exchange tubes. The heat exchangers used for the sole purpose of suitably understanding the elements of the invention and various alternatives with specific solutions have been chosen for the purpose of serving as heat exchangers for an EGR system.

The manner in which the heat exchanger is configured for different flow rate requirements is by making use of a heat exchanger sized for being capable of expelling heat according to the most demanding requirement. Without any adaptation, this exchanger will be oversized for lower heat expulsion requirements. The adaptation is carried out by reducing the passage section of the heat exchange tubes (3) with a plurality of caps (1).

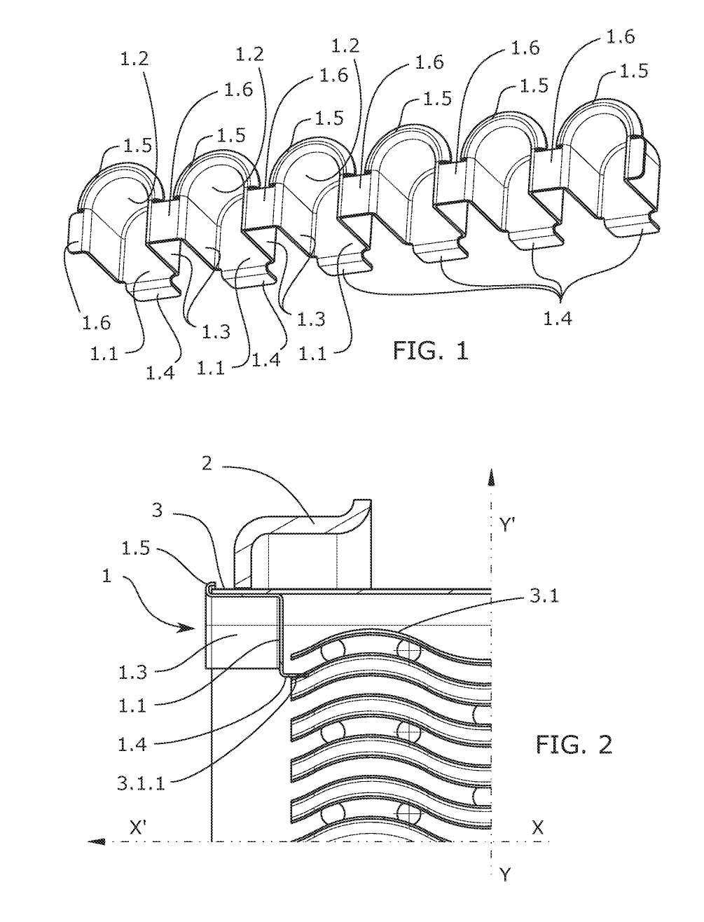

FIG. 1 shows an embodiment of a plurality of caps (1), connected consecutively by means of a connecting segment (1.6). Each of the caps (1) is an element configured for being housed in the intake end of a heat exchange tube (3) covering part of its section, as will be described below.

The heat exchange tubes (3) are planar tubes, as indicated above, and furthermore have inner fins (3.1.1) extending according to a longitudinal direction (X-X′), the longitudinal direction of the exchange tube (3). The inner fins (3.1.1) configure inside the exchange tube (3) a plurality of channels also extended in the longitudinal direction X-X′. The presence of these channels allows the situation where if a cap (1) occludes the inlet of one of the channels, the entire channel is disabled, and it is equivalent to the passage section of the exchange tube (3) being reduced along its entire length.

Longitudinal direction X-X′ is the main direction along which the exchange tube (3) extends. Of all the possible transverse or essentially perpendicular directions, the direction extending in the direction parallel to the main plane of the exchange tube (3) will be identified as transverse direction Y-Y′.

Having described the configuration of the exchange tubes (3) for these embodiments, according to the section of the tube and the transverse direction Y-Y′, there is at least one channel located at the end demarcated by the side arcuate segments of the exchange tube (3).

In contrast, the inner fins (3.1.1) form a plurality of channels distributed along the transverse direction Y-Y′.

In the selected embodiments of the invention, the caps (1) are configured for covering the first end channel, the one coinciding with the arcuate segment of the cross-section of the exchange tube (3) and at least one or more channels adjacent to this end channel reducing the effective section of the exchange tube. Given that all the exchange tubes (3) attached at their ends to the same baffle (2) have the same reduction in section, the temperatures of all of them are very close to one another such that there are no different longitudinal expansions causing thermal fatigue.

The embodiment of FIG. 1 shows each of the caps (1) with a closure surface (1.1) configured for being housed inside the exchange tube (3) covering the ends of the channels. Part of this closure surface (1.1) is configured as a half disc for covering the end channel and then extends in the form of a rectangular flat bar for covering the part of the end channel not covered by the half disc, if that is the case, and one or more adjacent channels.

In addition to the closure surface (1.1), each of the caps (1) shows a side surface (1.2, 1.3) configured for fitting snugly against the inner surface of the exchange tube (3). A first side surface (1.2) in the form of a cylindrical sector and two second planar side surfaces (1.3). The first side surface (1.2) in the form of a cylindrical sector internally fits snugly against the wall in the form of a cylindrical sector of the exchange tube (3), and the second planar side surfaces (1.3) prolong the side wall through the planar wall corresponding to the segments having a straight section.

In these embodiments, the channels extending along the longitudinal direction X-X′ of the exchange tube (3) show a winding configuration, as can be seen in FIG. 2. This winding configuration of the inner fins (3.1.1) is achieved by means of a specific bending of a metal plate (3.1). The bends of the metal plate (3.1) are the inner fins (3.1.1) and instead of making them straight, these bends are made such that they are winding. The inner fins (3.1.1) emerge from the rest of the bent metal plate (3.1) such that said metal plate (3.1) continues to have an essentially planar face. This planar face is what is braze-welded to the inner planar wall of the exchange tube (3). The inner fins (3.1.1) emerge from an inner face of an exchange tube (3) until reaching the opposite inner face. A channel is thereby limited by two consecutive fins (3.1.1) according to the transverse direction Y-Y′; and between a planar inner wall of the exchange tube (3) and the metal plate (3.1) supporting the inner fins (3.1.1) which in turn is welded to the opposite planar inner wall of the same exchange tube (3), these last two spaced from one another according to a direction perpendicular to the main plane of the planar exchange tube (3).

The winding configuration of the fins (3.1.1) gives rise to the position of the walls of the inner fins (3.1.1) at the end thereof according to the direction X-X′, where the cap (1) is supported, not being predictable. Especially in those cases in which the bent metal plate (3.1) giving rise to the inner fins (3.1.1) being manufactured continuously and cut into segments having a given length.

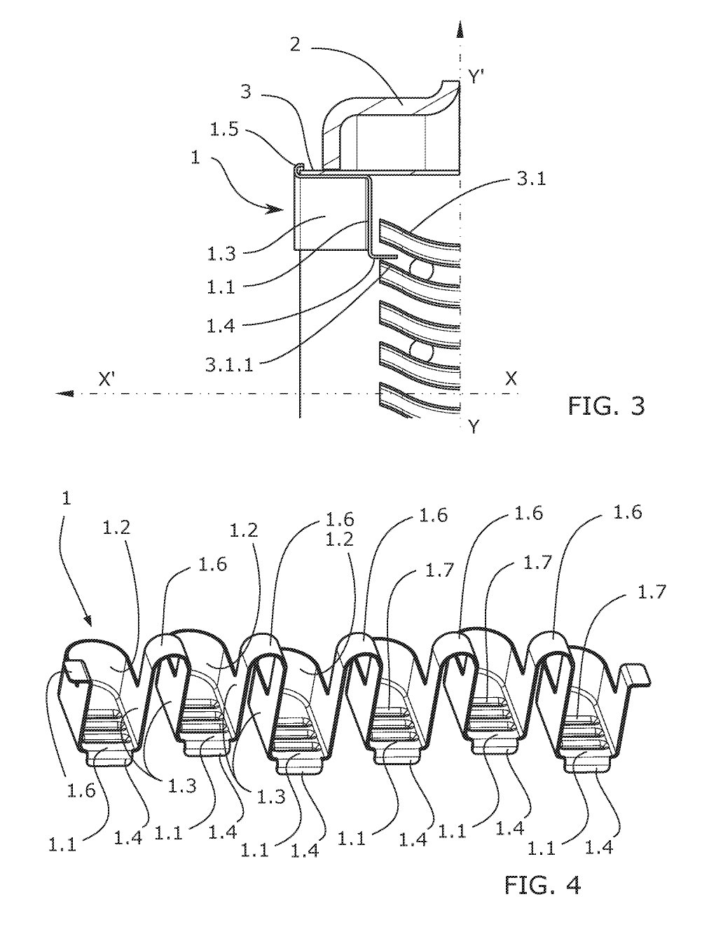

In these cases, the closure surface (1.1) of the cap (1) can only partially cover one of the channels, not suitably determining the degree of reduction in section of the exchange tube (3). The embodiment shown in FIGS. 2 and 3 shows a tab (1.4), which can be oblique or perpendicular, facing the inner fins (3.1.1), closing to a greater extent the passage to the partial opening that the closure surface (1.1) may leave.

The embodiment shown in FIGS. 1 to 3 also shows a supporting surface (1.5) configured for being outside the exchange tube (3) and being supported either on the securing baffle (2) for securing the end of the exchange tube (3) where the cap (1) is housed or on the outer edge of said exchange tube (3).

FIGS. 2 and 3 show the exchange tube (3) projecting from the surface of the baffle (2). In this case, the supporting surface (1.5) is the end edge of the exchange tube (3), and in this embodiment the supporting surface (1.5) is configured in the form of a semicircular flat bar for being supported on the free edge of the arcuate segment of the exchange tube (3).

If the exchange tube (3) ends flush with the baffle (2) or projects very little, support can be established directly on the baffle (2).

The walls of the cap (1), the curved surface (1.2) and the side surfaces (1.3) configure a continuous surface, assuring the leak-tight closure with the wall of the exchange tube (3) in the contact area.

When manufacturing heat exchangers with planar exchange tubes (3), one of the difficulties arising is the different position according to the longitudinal direction X-X′ of the ends of the exchange tubes (3).

According to the first inventive aspect, given that a plurality of caps (1) is connected through a connecting segment integrally connecting them, the insertion of the caps (1) in the tubes would give rise to some caps (1) being inserted all the way in and other caps (1) only being partially inserted.

To solve this problem, a second embodiment of an element with caps (1) is proposed and shown separately in FIG. 4. In this element, the connecting segment (1.6) is arc-shaped and is configured as an elastically deformable element. With this configuration, it is possible to insert each cap (1) in an exchange tube (3) even if each of the exchange tubes (3) emerges from the baffle (2) a different distance. The elastically deformable element adapts by deformation to allow this different position according to the longitudinal direction X-X′.

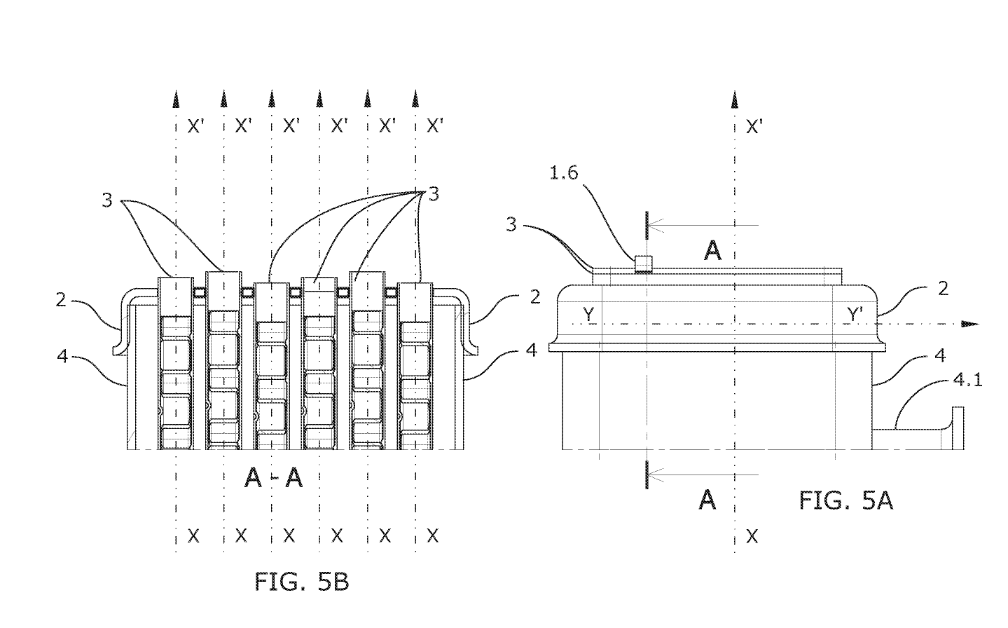

FIG. 5A shows the end of a heat exchanger with exchange tubes (3) emerging from the baffle (2) a different distance according to the longitudinal direction X-X′. Reference number 3 refers to two different corners, the corners corresponding to the ends of two exchange tubes (3) seen from the side and located in a different position according to the longitudinal direction X-X′.

Said FIG. 5A and FIG. 5B show the transverse direction Y-Y′, and according to this direction the width of the exchange tube (3), i.e., the distance between the ends of its section, and its thickness, i.e., the separation between planar plates, can be seen. The section plane giving rise to the section shown in FIG. 5B where each of the exchange tubes (3) clearly emerges from the baffle (2) a different distance according to the longitudinal direction X-X′ is also indicated.

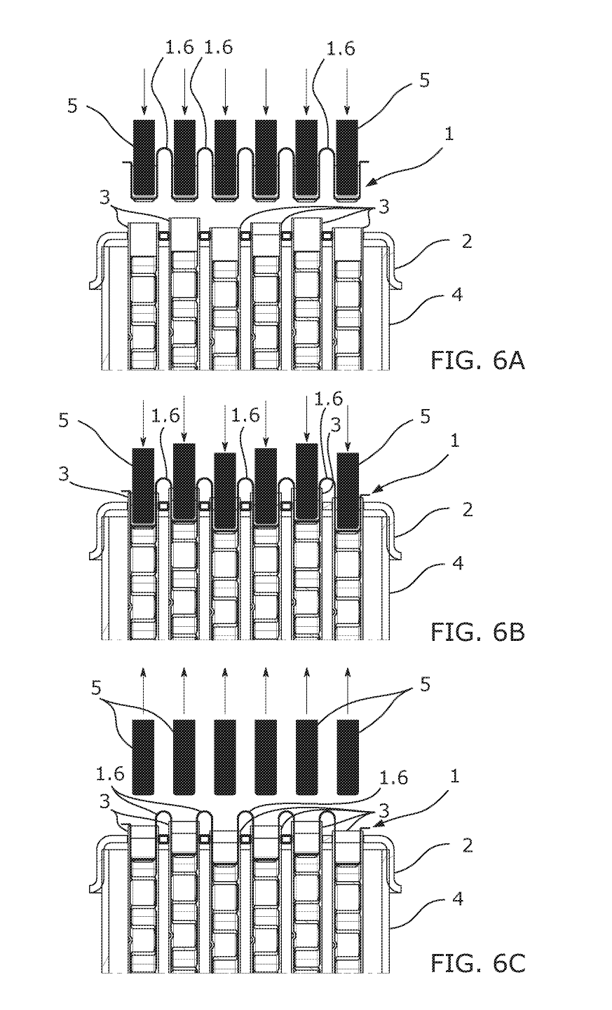

A manufacturing method for manufacturing a heat exchanger like the one described up until now is also object of this invention. The different steps of the method are schematically shown in FIGS. 6A, 6B and 6C. The method comprises the following steps:
providing a heat exchanger for internal combustion engines, comprising a bundle of exchange tubes (3), wherein said exchange tubes (3) are tubes configured as planar tubes, with inner fins (3.1.1), extending according to a longitudinal direction (X X′), and wherein the inner fins (3.1.1) internally configure a plurality of channels extended according to said longitudinal direction (X-X′) and distributed according to a transverse direction (Y-Y′) with respect to said longitudinal direction (X X′), the exchange tubes (3) being extended between a first baffle (2) and either a second baffle or the shell (4)
providing a flow-limiting element configured as a plurality of caps (1) consecutively connected and attached by means of a connecting segment (1.6).

Up to this point elements suitable for assembly are provided. The heat exchanger with the described configuration of planar exchange tubes (3) and the flow-limiting element with caps (1).
arranging the heat exchanger in fixing means,
arranging the flow-limiting element in a plurality of punches (5), movable in the longitudinal direction (X-X′) established by the exchange tubes (3) of the heat exchanger once it is fixed in the fixing means, such that:
   each cap (1) is housed on a different punch (5),
   each cap (1) housed on a punch (5) is aligned with a different exchange tube (3).

The heat exchanger is fixed such that a plurality of punches (5) are distributed leaving each punch (5) to coincide according to the longitudinal direction X-X′ with one of the exchange tubes (3), one punch (5) per cap (1) to be inserted.

FIG. 6A shows a section view of the fixed heat exchanger and above it, according to the orientation of the drawing, the plurality of punches (5) already housed inside each corresponding cap (1).
moving the punches (5) in the longitudinal direction until inserting all the caps (1) in their corresponding heat exchange tube (3).

The downward movement of the punches (5) also causes the downward movement of the limiting element with each of its caps (1). In this embodiment where the caps (1) are linked by the elastically deformable connecting segment, a set of punches (5) in which movement of each punch (5) is independent has also been provided. In other words, each punch (5) exerts force independently of others and its movement does not impart the same movement in other punches (5). FIG. 6B shows the insertion of the caps (1) pushed by the punches (5) entering to a greater or lesser extent depending on how much their corresponding exchange tube (3) projects. Therefore, an exchange tube (3) that projects significantly does not prevent the entrance of the caps (1) that are inserted in the remaining exchange tubes (3) until reaching their end position, assuring the closure against the inner channels.
removing the punches (5),
releasing the heat exchanger.

The punches (5) are released with these operations, as shown in FIG. 6C, leaving the caps (1) inserted in their end position. Friction with the exchange tube (3) keeps this insertion position stable.

In this embodiment, the weld between the different elements making up the heat exchanger has been formed by using a brazing paste and with passage through a furnace to get this brazing paste to melt. In the case of the bent metal plate (3.1) configuring the inner fins (3.1.1), the attachment with one of the inner faces of the exchange tube (3) has been formed by means of a brazing foil. In this embodiment, this brazing foil has been spread out and has also been used for attaching each of the caps (1) to the exchange tube (3).

In FIGS. 6A to 6C, the punches (5) are shown in a section view, filling the inner cavity of each of the caps (1). Nevertheless, according to other embodiments, these same punches (5) have projections pressing against the tab (1.4) in order to deform it, fitting more snugly against the inner fins (3.1.1), assuring the closure between the cap (1) and the inner fins (3.1.1). The best closure of the channels is assured with this deformation.

FIGS. 7 and 8 show perspective views of the final position of the limiting element comprising the plurality of caps (1) inserted in the end of the exchange tubes (3), closing several channels, i.e., the channels located at the end according to the transverse direction Y-Y′.

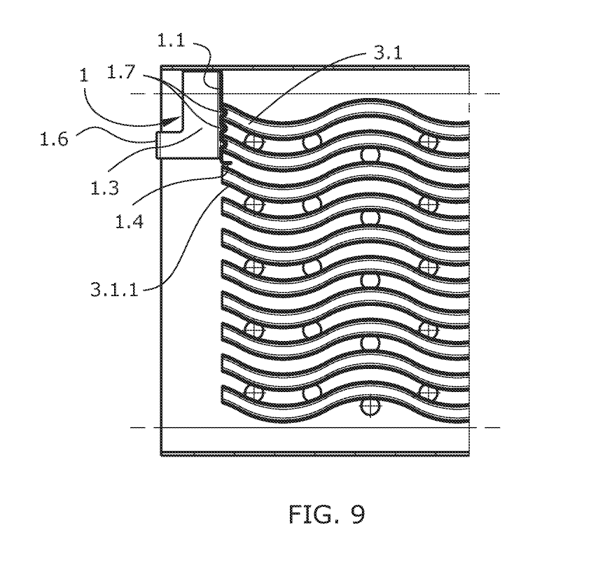

These same views of FIGS. 7 and 8 and the section view shown in FIG. 9 show a specific configuration that can be applied to any one of the preceding embodiments, where a plurality of indentations (1.7) is projected against the final ends of the inner fins (3.1.1), improving the closure of the channels.

A third aspect of the invention relates to a flow-limiting device for heat exchangers identified as embodiment #1; said device is configured for being installed in heat exchangers for internal combustion engines formed by means of exchange tubes (3) for the exchange of heat between a hot gas and a coolant fluid; wherein the exchange tubes (3) are tubes configured as planar tubes, with inner fins (3.1.1), extending according to a longitudinal direction (X-X′), and where the inner fins (3.1.1) internally configure a plurality of channels extended according to said longitudinal direction (X-X′) and distributed according to the transverse direction (Y-Y′) with respect to said longitudinal direction (X-X′), wherein said device is configured as a plurality of caps (1) aligned with one another and attached by means of a connecting segment (1.6), each of the caps (1) being insertable in one end of a different exchange tube (3) for covering one or more of the channels.

An embodiment identified as #2 is formed like the device of embodiment #1, wherein at least one cap (1) comprises:
a closure surface (1.1) configured for being housed inside the exchange tube (3); and
a side surface (1.2, 1.3) configured for fitting snugly against the inner surface of the exchange tube (3).

An embodiment identified as #3 is formed like the device of embodiment #1 or the device of embodiment #2, wherein at least one cap (1) has a supporting surface (1.5) configured for being outside the exchange tube (3) and being supported either on a securing baffle (2) for securing the end of the exchange tube (3) or on the outer edge of the exchange tube (3).

An embodiment identified as #4 is formed like the device of embodiment #2 or the device of embodiment #3, wherein, in at least one cap (1), the closure surface (1.1) and the supporting surface (1.5) are separated from one another by means of the side surface (1.2, 1.3).

An embodiment identified as #5 is formed like the device according to any of embodiments #2 to #4, wherein the side surface (1.2, 1.3) is configured for being adapted to a planar exchange tube (3) with a cross-section according to two straight parallel segments connected at their ends by means of two arcs; where said side surface (1.2, 1.3) comprises a curved surface (1.2) adapted for fitting snugly against one of the curved ends of the section of the exchange tube (3).

An embodiment identified as #6 is formed like the device according to any of embodiments #2 to #4 and embodiment #5, wherein the side surface (1.2, 1.3) comprises respective planar side surfaces (1.3) configured for fitting snugly against a portion of the inner surface of the wall of the exchange tube (3) corresponding to the cross-sectional straight segments of said exchange tube (3), where both side surfaces (1.3) are arranged in opposition.

An embodiment identified as #7 is formed like the device according to embodiment #6, wherein the curved surface (1.2) and the side surfaces (1.3) configure a continuous connecting surface.

An embodiment identified as #8 is formed like the device according to any of embodiments #1 to #7, wherein the closure surface (1.1) has a tab (1.4) oblique or perpendicular to said closure surface (1.1), configured for at least partially entering one of the channels of the exchange tubes (3) to establish better closure of said channels.

An embodiment identified as #9 is formed like the device according to any of embodiments #1 to #8, wherein at least one of the connecting segments (1.6) is configured according to an elastically deformable element to allow the insertion of each cap (1) in its corresponding exchange tube (3) with different positions according to the longitudinal direction (X-X′).

1. A heat exchanger for internal combustion engines, comprising a bundle of exchange tubes (3) for the exchange of heat between a hot gas and a coolant fluid; wherein the exchange tubes (3) are tubes configured as planar tubes, with inner fins (3.1.1), extending according to a longitudinal direction (X-X′), and wherein the inner fins (3.1.1) internally configure a plurality of channels extended according to said longitudinal direction (X-X′) and distributed according to a transverse direction (Y-Y′) with respect to said longitudinal direction (X-X′), characterized in that it comprises at least one element configured as a plurality of caps (1) consecutively connected and attached by means of a connecting segment (1.6), each of the caps (1) housed in one end of a different exchange tube (3), covering one or more of the channels thereof to reduce the passage section thereof.

2. The heat exchanger of claim 1, wherein at least one cap (1) comprises:
a closure surface (1.1) configured for being housed inside the exchange tube (3) limiting its passage section; and
a side surface (1.2, 1.3) configured for fitting snugly against the inner surface of the exchange tube (3).

3. The heat exchanger of claim 2, wherein at least one cap (1) has a supporting surface (1.5) configured for being outside the exchange tube (3) and being supported on either the securing baffle (2) for securing the end of the exchange tube (3) where the cap (1) is housed or on the outer edge of said exchange tube (3).

4. The heat exchanger of claim 3, wherein the closure surface (1.1) and the supporting surface (1.5) in at least one cap (1) are separated from one another by means of the side surface (1.2, 1.3).

5. The heat exchanger according to claim 2, wherein the side surface (1.2, 1.3) is configured for being adapted to a planar exchange tube (3) with a cross-section according to two straight parallel segments connected at their ends by means of two arcs; where said side surface (1.2, 1.3) comprises a curved surface (1.2) adapted for fitting snugly against one of the curved ends of the section of the exchange tube (3).

6. The heat exchanger of claim 2, wherein the side surface (1.2, 1.3) comprises respective planar side surfaces (1.3) configured for fitting snugly against a portion of the inner surface of the wall of the exchange tube (3) corresponding to the cross-sectional straight segments of said exchange tube (3), where both side surfaces (1.3) are arranged in opposition.

7. The heat exchanger of claim 5, wherein the curved surface (1.2) and the side surfaces (1.3) configure a continuous connecting surface.

8. The heat exchanger of claim 2, wherein in at least one cap (1) the closure surface (1.1) has a tab (1.4) that is oblique or perpendicular to said closure surface (1.1), configured for at least partially entering one of the channels of the exchange tube (3) in which it is housed to establish better closure of said channels.

9. The heat exchanger of claim 1, wherein the channels of the exchange tubes (3) are configured by a plate (3.1) die cut and bent configured for forming fins (3.1.1), these fins (3.1.1) being the fins that demarcate the channels of said exchange tube (3).

10. The heat exchanger of claim 1, wherein at least one of the connecting segments (1.6) is configured according to an elastically deformable element to allow the insertion of each cap (1) in its corresponding exchange tube (3) with different positions according to the longitudinal direction (X-X′).

11. The heat exchanger of claim 2, wherein the closure surface (1.1) comprises indentations (1.7) projected towards the side where the inner fins (3.1.1) are located to improve the closure of the channels.

12. A method for manufacturing a heat exchanger, the method comprising:
providing a heat exchanger for internal combustion engines, comprising a bundle of exchange tubes (3), wherein said exchange tubes (3) are tubes configured as planar tubes, with inner fins (3.1.1), extending according to a longitudinal direction (X-X′), and wherein the inner fins (3.1.1) internally configure a plurality of channels extended according to said longitudinal direction (X-X′) and distributed according to a transverse direction (Y-Y′) with respect to said longitudinal direction (X-X′), the exchange tubes (3) being extended between a first baffle (2) and either a second baffle or the shell (4);
providing a flow-limiting element configured as a plurality of caps (1) consecutively connected and attached by a connecting segment (1.6);
arranging the heat exchanger in a support;
arranging the flow-limiting element in a plurality of punches (5), movable in the longitudinal direction (X-X′) established by the exchange tubes (3) of the heat exchanger once it is fixed in the support, such that:
each cap (1) is housed on a different punch (5); and
each cap (1) housed on a punch (5) is aligned with a different exchange tube (3);
moving the punches (5) in the longitudinal direction until inserting all the caps (1) in their corresponding heat exchange tube (3);
removing the punches (5); and
releasing the heat exchanger.

13. The method of claim 12, wherein:
the movement of each of the punches (5) is independent such that after imparting an insertion force, each cap (1) is allowed to be housed in its corresponding exchange tube (3) even if the exchange tubes (3) are not aligned according to the transverse direction (Y-Y′) with respect to the longitudinal direction (X-X′) of insertion.

14. The method of claim 12,
one or more punches (5) have a pressure rib on the tab (1.4) of the cap (1) to force deformation thereof against the separations between channels of the exchange tube (3) to establish better closure of said channels.

15. The method of claim 13, wherein one or more punches (5) have a pressure rib on the tab (1.4) of the cap (1) to force deformation thereof against the separations between channels of the exchange tube (3) to establish better closure of said channels.
